(19) United States
(12) Patent Application Publication
(10) Pub. No.: US 2025/0387966 A1
(43) Pub. Date: Dec. 25, 2025

(54) METHOD FOR PRODUCING A BLOW-MOLDED PART AND BLOW-MOLDED PART

(71) Applicant: Ti Automotive Technology Center GmbH, Rastatt (DE)

(72) Inventors: Irfan Kizilay, Reilingen (DE); Manuel Lindow, Gernsbach (DE); Stefan Leipold, Seltz (FR); Florian Deibel, Sinzheim (DE); Thorsten Schaefer, Steinfeld (DE)

(21) Appl. No.: 19/244,453

(22) Filed: Jun. 20, 2025

(30) Foreign Application Priority Data
Jun. 21, 2024 (EP) 24183843.2

(51) Int. Cl. B29C 49/20; B29L 31/00; F17C 1/16

(52) U.S. Cl. CPC B29C 49/20; F17C 1/16; B29C 2049/2008; B29L 2031/7156

(57) ABSTRACT

A method for producing a blow-molded part, where a support structure is provided and arranged in a blow mold, a preform is introduced into the blow mold in such a way that the support structure is at least partially enclosed by the preform, the blow mold is then closed and a base body surrounding the support structure is produced from the preform by blow molding. Thereby, the base body is connected to the support structure during blow molding in a materially bonded manner and/or form-fitting manner. A blow-molded part includes a base body, which encloses a cavity, and a support structure arranged inside the base body. The base body and the support structure delimit the cavity, and the base body and the support structure are connected to one another in a materially bonded manner.

### RELATED APPLICATIONS

The present disclosure claims priority to and the benefit of European Application 24183843.2, filed on Jun. 21, 2024, the entire contents of each of which are incorporated herein by reference.

### FIELD

The present disclosure relates to a method for producing a blow-molded part that is provided with a support structure. The present disclosure also relates to a blow-molded part produced using such a method.

### BACKGROUND

In the blow molding method, a tubular or flat preform is inserted into a blow mold, wherein the blow mold comes to rest against the outside of the preform and defines the outer contour of the blow-molded part. The blow mold usually comprises two blow-molding tools with a cavity that can be moved relative to each other, wherein the preform is pressed off at the edge regions of the cavity of the blow-molding tools when the blow-molding tools are closed. In this region, a seam is formed on the blow-molded part to be produced, wherein the blow-molded part is formed in the region of the cavity and protruding material, the parison waste, remains outside the cavity. The parison waste is removed from the blow-molded part after the blow molding method is complete.

Blow-molded parts have a wide range of application. For example, blow-molded parts are used in electromobility, especially in form of pipe arrangements, to be able to conduct temperature control media to various components of an electric vehicle, for example the batteries or a heat exchanger for controlling the temperature of the passenger compartment. Batteries only exhibit optimum performance within a limited temperature range, so that it can be necessary to heat or cool the batteries depending on the ambient temperature. It is also necessary to either cool or heat a passenger compartment depending on the ambient temperature. The pipe arrangement allows temperature control media with different temperatures to be distributed and fed to different components. Other areas of use are in stationary applications, for example in energy storage systems or in temperature control applications for heating and cooling circuits in building technology.

Blow-molded parts can also be used in form of containers, in particular as expansion vessels for temperature control media. Due to temperature changes, the volume of the temperature control medium can change. An increase in the temperature of the temperature control medium leads to an expansion of the temperature control medium. This causes the pressure in the expansion vessel to rise, wherein, above a certain pressure, air escapes from the expansion vessel via a valve. When the temperature of the temperature control medium subsequently normalizes, the temperature control medium contracts again, creating a vacuum. As a result, air flows into the expansion vessel via the valve until pressure equalization is achieved. In this respect, the expansion vessel is usually under overpressure or underpressure during operation, depending on the situation.

Such overpressures and underpressures place special demands on the structural strength of the expansion vessel, in particular on the structural strength and dimensional accuracy of media-carrying interfaces between the expansion vessel and other components as well as on the mechanical attachment points of the expansion vessel. Such demands cannot yet be met by blow-molded expansion vessels. It can therefore be necessary to insert a separate structural component into the expansion vessel as an interface. It can also be necessary to integrate additional interface elements such as screw caps for filling openings, pressure or vacuum relief valves, sensors for temperature or fill level or discharge connections for electrostatic equalization potentials. Structural components that take up installation space lead to restrictions in the embodiment of the blow-molded part.

From EP 3 259 110 B1, a method for extrusion blow molding a container made of thermoplastic material is known where an insert component with a feedthrough is arranged in such a way that the insert component is arranged on the outside of the container after extrusion blow molding.

### BRIEF SUMMARY

The present disclosure provides a simple method for producing a blow-molded part where blow-molded parts can be produced inexpensively.

In the method according to the present disclosure for producing a blow-molded part, a support structure is provided and arranged in a blow mold, a preform is introduced into the blow mold in such a way that the support structure is at least partially enclosed by the preform, the blow mold is then closed and a base body surrounding the support structure is produced from the preform by blow molding, wherein the base body is connected to the support structure in a materially bonded and/or form-fitting manner during the blow molding.

The preform is preferably formed tubular. When the preform is inserted into the blow mold, the preform is preferably placed over the support structure, so that the support structure is arranged inside the preform and surrounded by the tubular preform. During blow molding, the preform comes to rest against the support structure from the outside. Alternatively, the preform can be formed flat.

By means of blow molding, a cavity is formed that is delimited by the base body and the support structure. In particular, the cavity can be formed to accommodate and/or conduct a fluid. The fluid can be a gas or a liquid, for example a temperature control medium.

The ability to produce a simple and inexpensive materially bonded connection between the support structure and the base body is given in particular if the base body and the support structure are formed of plastic, wherein the plastic of the base body and the plastic of the support structure preferably have a similar melting temperature. This allows for a materially bonded connection to be achieved in a particularly energy-efficient and inexpensive way as reheating can be avoided. Preferably, the base body and the support structure are formed of the same plastic. Polymer material is considered to be particularly suitable as plastic for the base body and the support structure, especially preferred are polyolefins such as polypropylene and/or polyamide.

It is also conceivable to form the base body and/or the support structure in multiple layers, wherein different plastics are used for each layer. This means that the base body can be equipped with further additional functionalities, for example it is conceivable to integrate foams and thus achieve improved thermal insulation. It is also conceivable, by selecting suitable materials, to achieve improved chemical properties, for example improved stability, in particular improved compatibility with oil media.

The support structure can comprise elements that serve to connect the blow-molded part to other components. In particular, the elements can have or form an interface geometry. Interface geometries for the connection are screw threads, for example. These can be covered by a protective cover, wherein the protective cover serves to protect the interface geometry during the production of the blow-molded part. The protective cover can be removed after production, in particular after the blow molding operation. In doing so, it is particularly advantageous that particularly dimensionally accurate interface geometries can be provided, wherein the dimensional accuracy can be guaranteed by the protective cover even beyond the blow molding operation. This means that the interface geometry can be used for a connection with overpressure and/or underpressure function.

In principle, it is conceivable to realize the formation of the support structure or the interface geometries as a material composite of different material classes, for example a combination of plastic and metal or plastic and ceramic, particularly preferably in a materially bonded connection.

Due to the materially bonded connection, the base body and the support structure are firmly connected to each other. It is particularly advantageous to produce the materially bonded connection directly by means of the blow molding method during the shaping of the base body. If the support structure has protruding elements with connecting elements, connecting pieces and the like, the connection between the base body and the support structure can be formed to be media-tight, at least in the region of the protruding element. The media-tight connection can be achieved by a materially bonded connection in the course of the blow molding method. In such a case, it is not necessary to arrange additional sealing elements, for example flat gaskets or O-rings, between the base body and the support structure, which means that the number of individual components can be reduced. Furthermore, additional production steps to form a media-tight connection between the base body and the support structure can be omitted.

The support structure can have welding ribs on the outside. Said welding ribs are in particular formed to be connected to the base body in a materially bonded manner during blow molding. The welding ribs can be arranged on the outside of the support structure. During blow molding, the welding ribs melt through contact with the preform and connect with the base body in a materially bonded manner.

Furthermore, by means of the welding ribs, a targeted mechanical reinforcement of the blow-molded part can be achieved. In the regions where welding ribs are located, the blow-molded part can be structurally reinforced, so that higher forces can be absorbed and dissipated, at least in these areas. Higher forces can occur both with overpressure and underpressure within the blow-molded part. Moreover, the welding ribs can also improve the connection between the structural component and the base body. A linear embodiment of the welding ribs allows the welding ribs to be melted onto the preform in a targeted manner during blow molding. This is advantageous compared to a two-dimensional connection between the support structure and the preform. This reduces the tolerance requirements for the components, which is particularly advantageous with regard to the support structure which is often formed as an injection-molded component and has higher production tolerances and thus dimensional deviations, which can make it difficult to achieve an optimal two-dimensional connection between the support structure and the preform. The welding ribs, on the other hand, can have smaller production tolerances in a targeted manner with little effort, so that an improved connection between the welding rib and the preform is achieved. Due to the linear contact, larger dimensional deviations can also be tolerated. Furthermore, by introducing mechanical undercut structures into the support structure or the interface geometry, an additional increase in the mechanical load-bearing capacity of the connection can be achieved.

The support structure can comprise at least one connecting piece which protrudes from the support structure, wherein at least one welding rib is arranged on the outside of the connecting piece, wherein the welding rib of the connecting piece is connected to the base body in a materially bonded manner during blow molding.

The connecting piece can delimit a channel and be connected to the cavity of the base body in a flow-conducting manner. In particular, fluids can be fed into and out of the blow-molded part through the connecting piece. It is particularly preferred that the blow-molded part can only be connected in a flow-conducting manner via the connecting piece. By means of the welding rib of the connecting piece, a sealingly connection between the base body and the connecting piece is achieved. Depending on the application, the support structure can also comprise multiple connecting pieces, wherein each connecting piece preferably comprises a welding rib. The possibility of producing particularly dimensionally accurate interface geometries is particularly advantageous, especially for providing pressure- and vacuum-tight screw connections in the blow molding method.

The connecting piece can comprise an opening, wherein, by means of blow molding, the base body forms a cover region which covers the opening and wherein the opening is made accessible by removing the cover region allocated to the opening. The cover region forms a protective cover. Depending on how the blow molding method is carried out, the opening of the connecting piece can be covered by the cover region of the base body once the base body has been formed from the preform and the materially bonded connection between the base body and the support structure has been established. It can therefore be necessary to remove the material of the base body in the cover region in a subsequent production step. For this purpose, a bore can be introduced in the base body to create the opening or the wall of the base body can be cut out in the region of the opening. It is also conceivable to introduce a material weakening into the base body during blow molding, the material weakening forming a predetermined breaking point. Once the blow molding method is completed, the opening can be made accessible by tearing off the material in the region of the material weakening. The opening can also be produced by punching or hot cutting.

The blow mold can have at least two blow-molding tools, wherein the support structure and the preform are arranged between the two blow-molding tools before blow molding, wherein the blow-molding tools press the preform against the support structure when the blow mold is closed. The blow-molding tools can press-off the preform in such a way that a separation region is formed in the base body during blow molding. Preferably, the separation region surrounds the cover region, wherein the cover region of the base body covers the opening of the connecting piece after blow molding. The separation region is a targeted structural weakening of the base body, so that, after the blow molding operation, the base body can be separated in the separation region, the cover region can be removed and the opening of the connecting piece can be exposed. A separation in the separation region can preferably be carried out without tools and with little effort, for example by tearing off, which simplifies the production of the blow-molded part.

The blow-molding tools can be equipped with squeeze edges which, during blow molding, rest against the base body in a linear manner and with pretension. This allows a particularly easy removal of the cover region after blow molding. The separation region formed by the squeeze edges can be formed as a circumferential groove. The squeeze edges can be formed as ribs. Depending on the embodiment, the squeeze edges can also form cutting edges which make it particularly easy to separate the separation region. The cutting edges can be formed in such a way that the separation region is already severed when the blow mold is closed.

The connecting piece can comprise a connecting element for connecting to a connection component, wherein a protective element is arranged in the blow mold before blow molding in such a way that the protective element is arranged between the connecting element and the base body after blow molding. In doing so, the protective element protects the connecting element, so that the preform does not come into contact with the connecting element and an unintentional connection between the connecting element and the base body is prevented. After the blow molding operation, the base body can be cut through in the separation region, so that the cover region can be removed. This allows the protective element to be exposed and then removed. Preferably, the protective element is formed of a material that has a higher glass transition temperature than the material of the support structure and preform. This prevents the protective element from connecting with the support structure and/or the preform during blow molding. The protective element is preferably formed of plastic. The protective element can be formed of a thermoplastic, for example polyoxymethylene.

The support structure can be formed as a ribbed structure. This allows the support structure to be formed to save weight and material while maintaining structural stability. The ribbed structure is preferably formed to withstand both overpressure and underpressure. In the areas between the ribs, the structure of the blow-molded part can be deliberately formed structurally weaker. This type of structural weakening can be used, for example, to achieve defined areas for bulging in the event of overpressure within the blow-molded part.

The support structure can comprise a sensor holder. A sensor can be arranged on the sensor holder before blow molding, the sensor being arranged and fixed in the blow-molded part after the blow molding operation. It can be advantageous that the sensor holder formed by the support structure remains in the blow-molded part after blow molding, so that no additional work step is required to remove the sensor holder. This means that the blow-molded part can be produced particularly inexpensively. Various types of sensors can be attached to the sensor holder, in particular a fill level sensor, a temperature sensor or a pressure sensor.

The present disclosure also includes a blow-molded part which is produced by the method described. The blow-molded part according to the present disclosure comprises a base body, which encloses a cavity, and a support structure arranged inside the base body, wherein the base body and the support structure delimit the cavity, wherein the base body and the support structure are connected to one another in a materially bonded manner. A blow-molded part according to the present disclosure is obtainable by the method described above. The blow-molded part can be formed in particular as a container or as a pipe arrangement. If the blow-molded part is formed as a container, the container is closed and serves to accommodate a fluid. If the blow-molded part is formed as a pipe arrangement, the pipe arrangement has two pipe openings and is used to conduct fluids.

The support structure can comprise at least one connecting piece which protrudes from the support structure and is connected to the cavity in a flow-conducting manner. The connecting piece can be formed to connect the blow-molded part to a connection component in such a way that the blow-molded part can be connected to the connection component in a flow-conducting manner. Preferably, the connecting piece is formed tubular.

The connecting piece can comprise a connecting element for connecting to a connection component. Preferably, the connecting piece can be connected to the connection component by means of the connecting element in a form-fitting or friction-locking manner. For this purpose, the connecting element can preferably be formed as a thread, bayonet lock, press-fit thickening, clipping or sealing ring profile. By such means, a simple mountability can be achieved.

### BRIEF DESCRIPTION OF THE DRAWINGS

Some embodiments of the blow-molded part according to the present disclosure and the method according to the present disclosure are explained in more detail below with reference to the figures. These show, each schematically:

FIG. 1 a sectional view of a blow-molded part according to the present disclosure;

FIG. 2 a further sectional view of the blow-molded part;

FIG. 3 a detailed view of a connecting piece of the blow-molded part from FIG. 1 in section according to the production method according to the present disclosure;

FIG. 4 the support structure inside the preform during the production of the blow-molded part according to FIG. 1.

### DETAILED DESCRIPTION

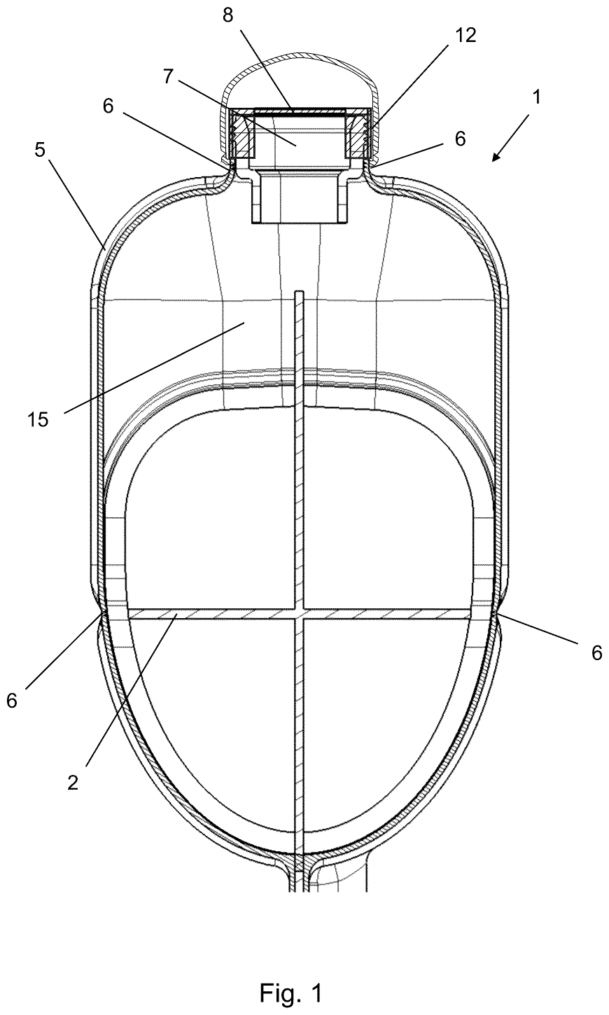

FIG. 1 shows a blow-molded part 1 formed as a container. The blow-molded part 1 comprises a base body 5 and a support structure 2 arranged inside the base body 5. The base body 5 and the support structure 2 surround a cavity 15. The cavity 15 is formed in particular to accommodate a fluid (not depicted). The fluid can be a gas or a liquid, for example a temperature control medium. The base body 5 and the support structure 2 are connected in a materially bonded manner. Besides the materially bonded connection, a form-fitting connection, for example produced by mechanical forming, is also conceivable as an alternative and/or addition.

The support structure 2 comprises a connecting piece 7 which protrudes from the support structure 2 and is connected to the cavity 15 in a flow-conducting manner. In particular, fluids can be fed into the blow-molded part 1 and out of the blow-molded part 1 through the connecting piece 7. The connecting piece 7 is formed to connect the blow-molded part 1 to a connection component (not depicted) in such a way that the blow-molded part 1 can be connected to the connection component in a flow-conducting manner. The connecting piece 7 is formed tubular. The connecting piece 7 can function as an opening for filling or emptying. The connecting piece 7 can also accommodate a sealing cap with an integrated sensor, in particular a pressure sensor for pressure monitoring.

The connecting piece 7 comprises a connecting element 12 to connect to the connection component (not depicted). The connecting piece 7 can be connected to the connection component by means of the connecting element 12 in a form-fitting manner. The connecting element 12 is formed as a thread in the present case. Alternatively, an embodiment as a bayonet lock is also possible. The connecting element 12 can also be formed as a press-fit thickening, clipping or sealing ring profile.

The base body 5 and the support structure 2 are formed of plastic, wherein the plastic of the base body 5 and the plastic of the support structure 2 have the same melting temperature. This allows for a materially bonded connection to be achieved in a particularly energy-efficient and therefore inexpensive way. The base body 5 and the support structure 2 are formed of a polyolefin, for example polypropylene. Alternatively, other thermoplastics or material composites can also be used. Due to the materially bonded connection, the base body 5 and the support structure 2 are firmly connected to each other in a media-tight manner.

The support structure 2 has welding ribs 6 on the outside which connect to the base body 5 in a materially bonded manner during blow molding. The welding ribs 6 are arranged on the outside of the support structure 2 and on the connecting element 12. During blow molding, the welding ribs 6 melt onto the preform 4. By means of the welding ribs 6, a targeted mechanical reinforcement of the blow-molded part 1 can be achieved.

One of the welding ribs 6 is arranged on the outside of the connecting piece 7, so that the base body 5 is connected to the connecting piece 7 in a materially bonded manner during blow molding. By means of the welding rib 6 on the connecting piece 7, a sealingly connection between the base body 5 and the connecting piece 7 is achieved.

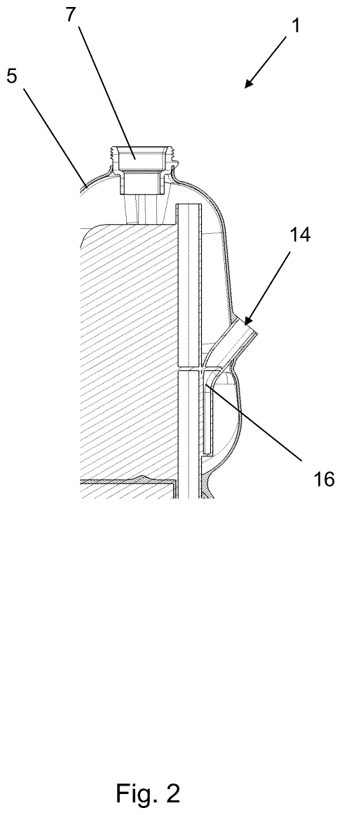

In FIG. 2, it can be seen that the support structure 2 of the blow-molded part 1 shown in FIG. 1 comprises a sensor holder 14. On the sensor holder 14, a sensor 16 is arranged, the sensor being arranged and fixed in the blow-molded part 1. In this exemplary embodiment, the sensor 16 is formed as a fill level sensor. Other sensors can also be arranged on the sensor holder, in particular a temperature sensor or a pressure sensor.

The blow-molded part 1 shown in FIG. 1 and FIG. 2 can also be formed as a pipe arrangement (not depicted). If the blow-molded part 1 is formed as a pipe arrangement, the pipe arrangement has two pipe openings and is used to conduct fluids.

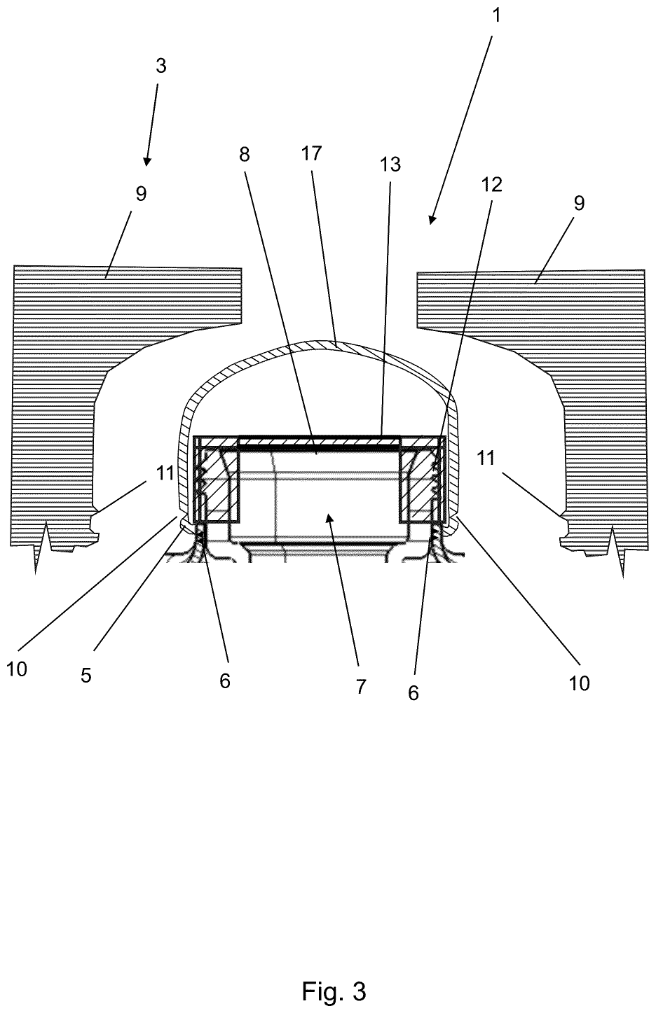

FIG. 3 shows in detail a region of the connecting piece 7 of the blow-molded part 1 from FIG. 1 immediately after completion of the blow molding method. The connecting piece 7 is arranged between two blow-molding tools 9 of a blow mold 3. The connecting piece 7 and the blow mold 3 are depicted only partially and therefore with a break edge.

The connecting piece 7 comprises an opening 8. Once the shaping of the base body 5 from a preform 4 has been completed and the materially bonded connection between the base body 5 and the support structure 2 has been established, the opening 8 of the connecting piece 7 is covered by a cover region 17 of the base body 5. It is therefore necessary to remove the material of the base body 5 in the cover region 17 in a subsequent production step.

The blow mold 3 has two blow-molding tools 9, wherein the support structure 2 and the preform 4 are arranged between the two blow-molding tools 9 before blow molding. When closing, the two blow-molding tools 9 of the blow mold 1 come to rest against the support structure 2 and press off the preform 4 in such a way that a separation region 10 is formed in the base body 5 during blow molding. The separation region 10 surrounds the cover region 17, wherein the cover region 17 covers the opening 8 of the connecting piece 7 after blow molding. The separation region 10 is a targeted structural weakening of the base body 5, so that, after the blow molding operation, the base body 5 can be separated in the separation region 10, the cover region 17 can be removed and the opening 8 of the connecting piece 7 can be exposed. A separation in the separation region 10 can be carried out without tools and with little effort, for example by tearing off, which further simplifies the production of the blow-molded part 1. However, a tool can also be used to cut off the cover region 17, which enables burr-free separation or separation with very low tolerances.

The two blow-molding tools 9 are equipped with squeeze edges 11 which, during blow molding, rest against the base body 5 in a linear manner and with force. This allows a particularly easy removal of the cover region 17 after blow molding. The separation region 10 formed by the squeeze edges 11 is formed as a circumferential groove. The squeeze edges 11 can also be formed as cutting edges, which allow for a particularly easy separation of the separation region 10, so that the separation region 10 is already severed when the blow mold 3 is closed.

The connecting piece 7 comprises a connecting element 12 for connecting to a connection component, wherein a protective element 13 is arranged in the blow mold 3 before blow molding in such a way that the protective element 13 is arranged between the connecting element 12 and the base body 5 after blow molding. The protective element 13 protects the connecting element 12, so that the preform 4 does not come into contact with the connecting element 12 and a connection between the connecting element 12 and the base body 5 is prevented. After the blow molding operation, the base body 5 is cut through in the separation region 10, so that the cover region 17 can be removed. This allows the protective element 13 to be exposed and then removed. The protective element 13 is formed of a material that has a higher melting temperature than the material of the support structure 2 and the preform 4. This can prevent the protective element 13 from connecting with the support structure 2 and/or the preform 4 during blow molding. The protective element 13 is made of polyoxymethylene.

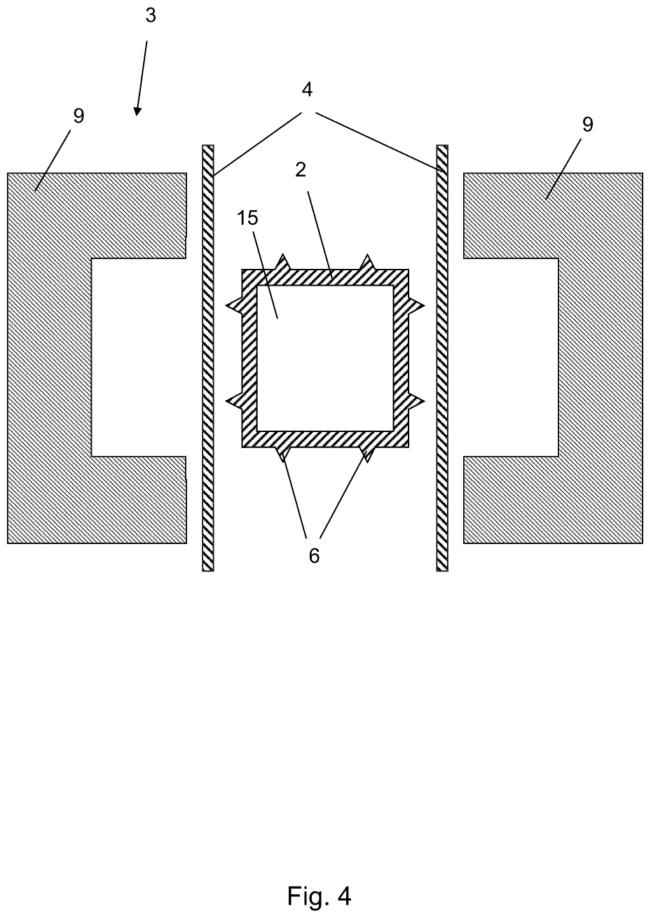

FIG. 4 schematically shows the support structure 2 and the preform 4 of the blow-molded part 1 from FIG. 1 during blow molding. The preform 4 is formed tubular. When the preform 4 is inserted into the blow mold 3, the preform 4 is placed over the support structure 2, so that the support structure 2 is arranged inside the preform 4. During blow molding, the preform 4 comes to rest against the support structure 2 from the outside. The blow mold 3 comprises two blow-molding tools 9 with a cavity that can be moved relative to each other, wherein the preform 4 is pressed off at the edge regions of the cavity of the blow-molding tools 9 when the blow-molding tools 9 are closed.

1. A method for producing a blow-molded part, comprising:
providing and arranging a support structure in a blow mold,
introducing a preform into the blow mold in such a way that the support structure is at least partially enclosed by the preform,
closing the blow mold and producing a base body surrounding the support structure from the preform by blow molding, wherein the base body is connected to the support structure during blow molding in a materially bonded manner and/or form-fitting manner.

2. The method according to claim 1, wherein the support structure has welding ribs on the outside which are connected to the base body in a materially bonded manner during blow molding.

3. The method according to claim 1, wherein the support structure comprises at least one connecting piece which protrudes from the support structure, wherein at least one welding rib is arranged on the outside of the connecting piece, wherein the welding rib of the connecting piece is connected to the base body in a materially bonded manner during blow molding.

4. The method according to claim 3, wherein the connecting piece comprises an opening, wherein, by way of blow molding, the base body forms a cover region which covers the opening and wherein the opening is made accessible by removing the cover region allocated to the opening.

5. The method according to claim 4, wherein the blow mold has at least two blow-molding tools, wherein the support structure and the preform are arranged between the two blow-molding tools before blow molding, and wherein the blow-molding tools press the preform against the support structure when the blow mold is closed.

6. The method according to claim 5, wherein the blow-molding tools press off the preform in such a way that a separation region is formed during blow molding.

7. The method according to claim 6, wherein the blow-molding tools are equipped with squeeze edges which, during blow-molding, rest against the base body in a linear manner and with pretension.

8. The method according to claim 5, wherein the connecting piece comprises a connecting element for connecting to a connection component, and wherein a protective element is arranged in the blow mold before blow molding in such a way that the protective element is arranged between the connecting element and the base body after blow molding.

9. The method according to claim 1, wherein the support structure is formed as a ribbed structure.

10. The method according to claim 1, wherein the support structure comprises a sensor holder.

11. A blow-molded part, comprising a base body, which encloses a cavity, and a support structure arranged inside the base body, wherein the base body and the support structure delimit the cavity, wherein the base body and the support structure are connected to one another in a materially bonded manner and/or form-fitting manner.

12. The blow-molded part according to claim 11, wherein the support structure comprises at least one connecting piece which protrudes from the support structure and is connected to the cavity in a flow-conducting manner.

13. The blow-molded part according to claim 12, wherein the connecting piece comprises a connecting element for connecting to a connection component.
